(19) United States
(12) Patent Application Publication
(10) Pub. No.: US 2019/0370828 A1
(43) Pub. Date: Dec. 5, 2019

(54) TIL Brokered Connections

(71) Applicant: The Indoor Lab, LLC, Dana Point, CA (US)

(72) Inventors: Patrick Joseph Mooney, Yorba Linda, CA (US); Patrick David Blattner, Dana Point, CA (US)

(73) Assignee: The Indoor Lab, LLC, Dana Point, CA (US)

(21) Appl. No.: 16/426,488

(22) Filed: May 30, 2019

Related U.S. Application Data
(60) Provisional application No. 62/677,892, filed on May 30, 2018.
(60) Provisional application No. 62/752,063, filed on Oct. 29, 2018.

(51) Int. Cl. G06Q 30/02; G06K 7/10; G06F 16/29

(52) U.S. Cl. CPC G06Q 30/0201; G06F 16/29; G06K 7/10297

(57) ABSTRACT

A system for making brokered connections. The system includes a predetermined space having multiple subareas, each subarea having an operator and each subarea having an RF sensor. The system also includes a database of participants, each participant having contact information including a name and an email address input into the database. An RF tag identifying each participant is worn by the participant as they move throughout the predetermined space. The database logs each time the RF tag identifying a participant visits each subarea. The system also includes a communication system for allowing each subarea operator to see a list of all the participants who visit their subarea, with personal identifying information about each individual masked. Finally, the communication system allows the subarea operator to request to connect with selected participants and if a selected participant accepts the connection request the personal identifying information about that individual is unmasked, permitting the subarea operator to see the unmasked participant name and email address.

### CROSS-REFERENCE TO RELATED APPLICATIONS

This application is related to the co-pending applications entitled “TIL BROKERED CONNECTIONS”, filed on May 30, 2018 under application No. 62/677,892, “IMPROVED TIL BROKERED CONNECTIONS”, filed on Oct. 29, 2018 under application No. 62/752,063, and the entire contents of each application is hereby incorporated by reference.

### STATEMENT REGARDING FEDERALLY SPONSORED RESEARCH

Not Applicable

### FIELD OF THE INVENTION

The present invention relates to a system and method for passive end to end tracking and two-way lead generation.

### DESCRIPTION OF THE PRIOR ART

Prior event tracking, for keeping track of participants visiting an event and each exhibitor booth they visit, has been active, which requires action by the participant. The action could be a click, a scan, a touch or a gaze, but always some sort of action by the participant.

What is needed is event tracking technology which is passive, and which requires no action on the part of the participant vising the event and the event exhibitors, and which permits two-way lead generation.

### SUMMARY OF THE INVENTION

The general purpose of the present invention, which will be described subsequently in greater detail, is to provide a system for making brokered connections. The system includes a predetermined space having multiple subareas, each subarea having an operator and each subarea having an RF sensor. The system also includes a database of participants, each participant having contact information including a name and an email address input into the database. An RF tag identifying each participant is worn by the participant as they move throughout the predetermined space. The database logs each time the RF tag identifying a participant visits each subarea. The system also includes a communication system for allowing each subarea operator to see a list of all the participants who visit their subarea, with personal identifying information about each individual masked. Finally, the communication system allows the subarea operator to request to connect with selected participants and if a selected participant accepts the connection request the personal identifying information about that individual is unmasked, permitting the subarea operator to see the unmasked participant name and email address.

The RF sensor can be Bluetooth, wi-fi, RFID or any other type of wireless sensor. The communication system sends a communication to each participant with a listing of each subarea who has requested permission to connect with the participant, and wherein the participant can selectively accept or decline the connection request of each subarea operator. The contact information of each participant includes a phone number. The participant communication provides statistical information to the participant. The statistical information includes the number of subareas visited and the total time spent visiting all the subareas, as well as the name of each subarea visited and the total time spent visiting each subarea, the number of average steps taken by the participant, the number of average calories burned by the participant, and wherein the statistical information includes graphical information showing the hourly average calories burned and the peak hour with the most calories burned. In addition to the RF sensor and the RF tag, LiDAR can also be employed, which reduces the number of cable drops and hardware required for event tracking.

The system and method also includes the option of being able to direct connect through the software and auto-invite through linked-in so they are connected through the linked-In profiles as well using open API's from LinkedIn.

The system and method wherein the communication system sends a communication to each participant with a listing of each subarea who has requested permission to connect with the participant, and wherein the participant can selectively accept or decline the connection request of each subarea operator.

The system and method wherein the listing is sent via attendee dashboard or via email. The attendee can also automatically connect with an exhibitor from the dashboard or via email without the exhibitor requesting a connection.

These together with other objects of the invention, along with the various features of novelty which characterize the invention, are pointed out with particularity in the claims annexed to and forming a part of this disclosure. For a better understanding of the invention, its operating advantages and the specific objects attained by is uses, reference should be made to the accompanying drawings and descriptive matter in which there are illustrated preferred embodiments of the invention.

### BRIEF DESCRIPTION OF THE DRAWING

The invention will be better understood and objects other than those set forth above will become apparent when consideration is given to the following detailed description thereof. Such description makes reference to the annexed drawing wherein:

FIG. 1 is a schematic showing an event layout.

FIG. 2 is a schematic showing a brokered connection.

FIG. 3 is a schematic showing an ORGANIZER dashboard.

FIG. 4 is a schematic showing an EXHIBITOR dashboard.

FIG. 5 is a schematic showing an ATTENDEE dashboard.

### DETAILED DESCRIPTION OF THE INVENTION

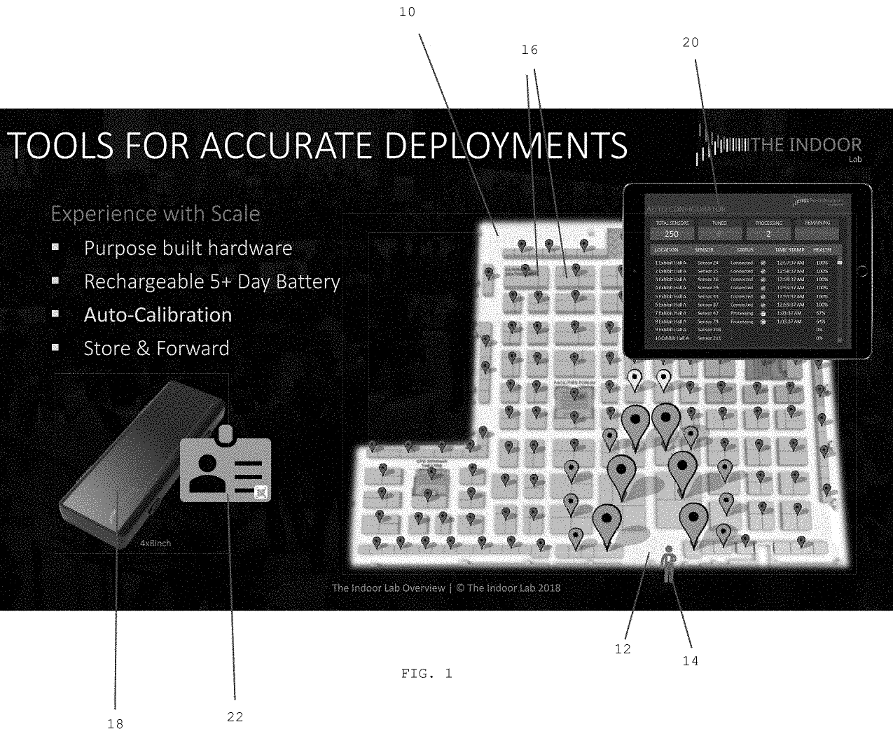

With reference now to the drawing, and in particular to FIGS. 1 through 5 thereof, a apparatus and method for making TIL brokered connections embodying the principles and concepts of the present invention will be described.

Referring to FIG. 1, the layout of a typical event is shown in which a hall 10 is shown, with an entrance 12 through which all participants 14 enter (also referred to as an attendee). The hall 10 contains many exhibitor booths 16, each booth being equipped with an RF sensor 18 which includes a rechargeable five plus day battery and can be discretely placed in the booth 16. Each attendee is logged into a database 20, which associates the attendee contact information and email address with a Bluetooth badge ID 22 (also referred to as a BLE badge) issued to each attendee. The RF sensor 18 could also be powered by a 110v outlet, if desired. As an attendee 14 visits booths 16 in the hall, and engages for more than a predetermined number of seconds (for example 30 seconds), the ID of the BLE badge is logged in the database against the Exhibitor ID, which is associated with a particular RF sensor and booth location, as well as a time stamp of the visit.

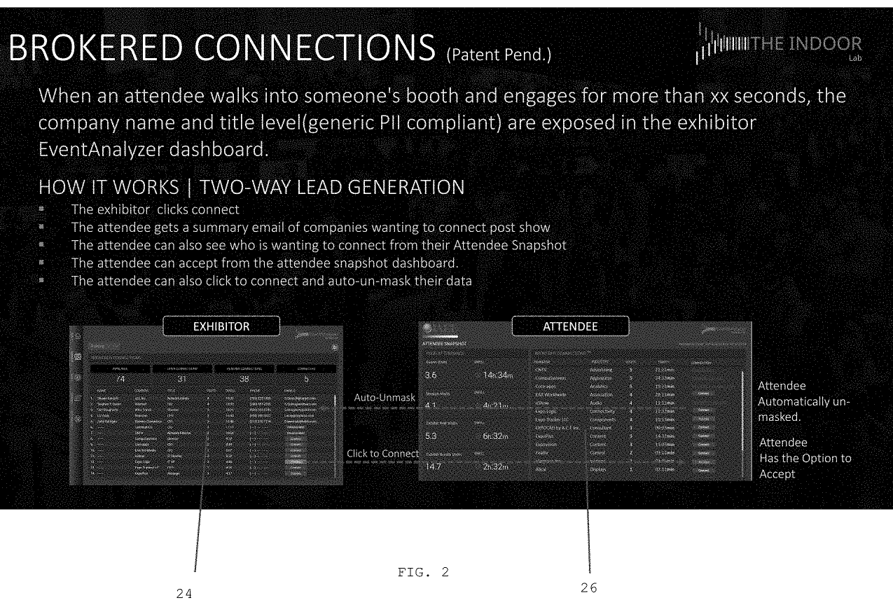

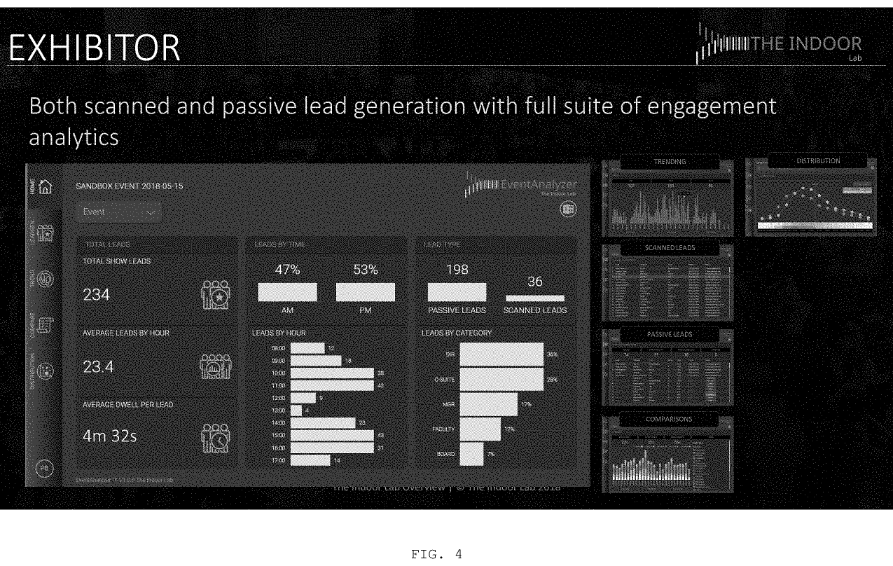

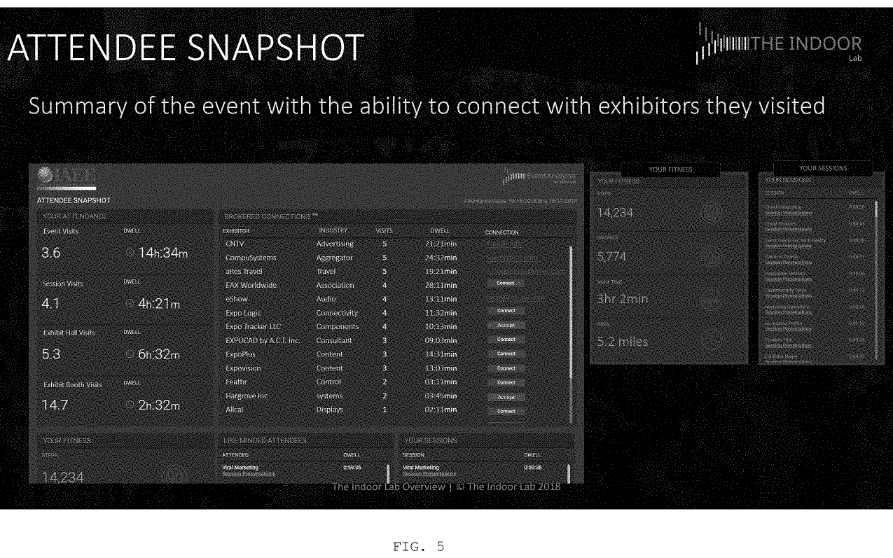

Referring to FIG. 2, a schematic view of a brokered connection is shown, which is created with the event software and which provides snapshots for the event organizer, each exhibitor and each attendee. Using the data logged in the database 20, the software provides each exhibitor with a listing of the attendees 14 who visited their booth 16, shown at 24, and containing the attendee contact information with the email address of the attendee masked. Each attendee 14 also receives a snapshot 26 which shows the exhibitors 16 the attendee visited. A brokered connection can be created either by the exhibitor clicking CONNECT in the exhibitor dashboard (best seen in FIG. 4) for a particular attendee, which the attendee has the option to ACCEPT from the attendee dashboard (best seen in FIG. 5), resulting in the unmasking of the attendee email and contact information, OR the attendee can simply click to automatically unmask their contact information and email of a particular exhibitor, on the attendee dashboard. In more detail, the two-way lead generation works by the exhibitor clicking CONNECT in their dashboard. The attendee gets a summary email of companies wanting to connect. The attendee also can see who wants to connect via their attendee snapshot. The attendee can accept from the attendee snapshot dashboard (or from the summary email) or the attendee can click to connect and automatically un-mask their contact information.

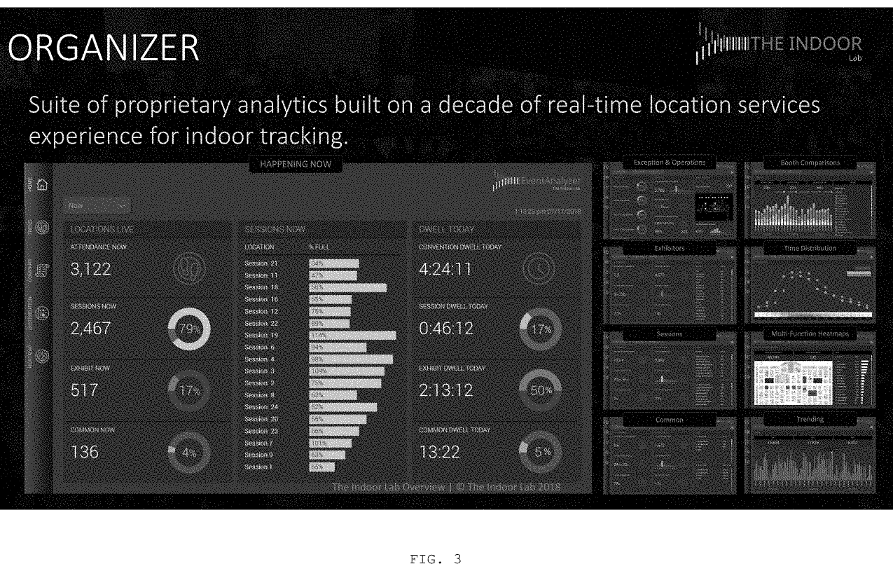

Referring to FIG. 3, an organizer dashboard is shown, which provides analytics at the organizer level.

Referring to FIG. 4, an exhibitor dashboard is shown, which provides analytics at the exhibitor level, including a passive leads screen used to create a brokered connection.

Referring to FIG. 5, an attendee dashboard is shown, which provides analytics at the attendee level, along with the ability to accept a connection request from an exhibitor or to auto connect with a selected exhibitor. The attendee dashboard also provides information on the number of exhibitors visited and the total time spent visiting all the exhibits (subareas). In addition, some fitness information is provided, including the average number of steps taken, the distance walked and the hourly average calories burned, along with the peak hour with the most calories burned.

An addition feature called Personal Connections will also be provided. This feature provides engagement by two attendees who are dwelling together for a designated period of time within a designated range of proximity. This will enable both attendees to see who they engaged with the most and directly connect with them. This is a subset of the brokered connection. Also, the option of being able to direction connect through our system and auto-invite through linked-in so they are connected through the linked-In profiles as well using open API's from LinkedIn can be provided.

Another embodiment of the invention would be to place RF sensors in a distributed fashion around the event space, and not in each exhibitor booth. For example, the RF sensors could be located in a grid pattern in the ceiling of the event space. Using position determination technology, the readings of multiple RF sensors of an attendee RF badge, the position of the attendee could be determined and the booth the attendee is visiting could be logged.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the apparatus and method for making TIL brokered connections. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for making brokered connections comprising:
a predetermined space having multiple subareas, each subarea having an operator and each subarea having an RF sensor;
a database of participants, each participant having contact information including a name and an email address input into the database;
an RF tag identifying each participant which is worn by the participant as they move throughout the predetermined space;
the database logging each time the RF tag identifying a participant visits each subarea;
a communication system for allowing each subarea operator to see a list of all the participants who visit their subarea, with personal identifying information about each individual masked;
the communication system allowing the subarea operator to request to connect with selected participants and if a selected participant accepts the connection request the personal identifying information about that individual is unmasked, permitting the subarea operator to see the unmasked participant name and email address.

2. The system for making brokered connections of claim 1 wherein the RF sensor is selected from the group consisting of Bluetooth, wi-fi, RFID or any other type of wireless sensor.

3. The system for making brokered connections of claim 1 wherein the communication system sends a communication to each participant with a listing of each subarea who has requested permission to connect with the participant, and wherein the participant can selectively accept or decline the connection request of each subarea operator.

4. The system for making brokered connections of claim 3 further wherein the contact information of each participant includes a phone number.

5. The system for making brokered connections of claim 3 wherein the participant communication provides statistical information to the participant.

6. The system for making brokered connections of claim 5 wherein the statistical information includes the number of subareas visited and the total time spent visiting all the subareas.

7. The system for making brokered connections of claim 5 wherein the statistical information includes the name of each subarea visited and the total time spent visiting each subarea.

8. The system for making brokered connections of claim 5 wherein the statistical information includes the number of average steps taken by the participant.

9. The system for making brokered connections of claim 5 wherein the statistical information includes the number of average calories burned by the participant.

10. The system for making brokered connections of claim 5 wherein the statistical information includes graphical information showing the hourly average calories burned and the peak hour with the most calories burned.

11. A method for making brokered connections comprising:
providing a predetermined space having multiple subareas, each subarea having an operator and each subarea having an RF sensor;
providing a database of participants, each participant having contact information including a name and an email address input into the database;
providing an RF tag identifying each participant which is worn by the participant as they move throughout the predetermined space;
logging in the database each time the RF tag identifying a participant visits each subarea;
providing a communication system for allowing each subarea operator to see a list of all the participants who visit their subarea, with personal identifying information about each individual masked;
the communication system allowing the subarea operator to request to connect with selected participants and if a selected participant accepts the connection request the personal identifying information about that individual is unmasked, permitting the subarea operator to see the unmasked participant name and email address.

12. The method for making brokered connections of claim 11 wherein the communication system allows the attendee to also connect with the exhibitor and auto-unmask the exhibitor data in the exhibitor dashboard.

13. The method for making brokered connections of claim 11 further including having a page that provides engagement by two attendees who are dwelling together for a designated period of time within a designated range of proximity known as personal connections.

14. The method for making brokered connections of claim 13 further including the option of being able to direction connect through our system and auto-invite through linked-In so they are connected through the linked-In profiles as well using open API's from Linked-In.

15. The method for making brokered connections of claim 11 wherein the communication system sends a communication to each participant with a listing of each subarea who has requested permission to connect with the participant, and wherein the participant can selectively accept or decline the connection request of each subarea operator.

16. The method for making brokered connections of claim 15 wherein the listing is sent via attendee dashboard.

17. The method for making brokered connections of claim 15 wherein the listing is available via an email.

18. The method for making brokered connections of claim 11 wherein an attendee can automatically connect with an exhibitor from a dashboard or via an email, without the exhibitor requesting a connection.

19. A system for making brokered connections comprising:
a predetermined space having multiple subareas, each subarea having an operator;
a plurality of RF sensors arranged in the predetermined space;
a database of participants, each participant having contact information including a name and an email address input into the database;
an RF tag identifying each participant which is worn by the participant as they move throughout the predetermined space;
position determination technology which is receives readings from the plurality of RF sensors and determines the location of a participant in a subarea;
the database logging each time the RF tag identifying a participant visits each subarea;
a communication system for allowing each subarea operator to see a list of all the participants who visit their subarea, with personal identifying information about each individual masked;
the communication system allowing the subarea operator to request to connect with selected participants and if a selected participant accepts the connection request the personal identifying information about that individual is unmasked, permitting the subarea operator to see the unmasked participant name and email address.
